(19) United States
(12) Patent Application Publication
(10) Pub. No.: US 2025/0164130 A1
(43) Pub. Date: May 22, 2025

(54) LIQUID MICRONIZATION APPARATUS

(71) Applicant: Panasonic Intellectual Property Management Co., Ltd., Osaka (JP)

(72) Inventors: Yuma YASUFUKU, Aichi (JP); Masayoshi KONDO, Osaka (JP)

(73) Assignee: Panasonic Intellectual Property Management Co., Ltd., Osaka (JP)

(21) Appl. No.: 18/950,007

(22) Filed: Nov. 16, 2024

(30) Foreign Application Priority Data
Nov. 22, 2023 (JP) 2023-198075

(51) Int. Cl. F24F 11/30; F24F 6/02; F24F 6/16; F24F 11/00; F24F 110/20; F24F 140/00

(52) U.S. Cl. CPC F24F 11/30; F24F 6/02; F24F 6/16; F24F 11/0008; F24F 2110/20; F24F 2140/00

(57) ABSTRACT

Liquid micronization apparatus according to the present disclosure includes: water storage that stores water to be micronized; water supplier that supplies water to water storage; drainage that drains water stored in water storage; remaining water amount acquirer that acquires a remaining water amount of water storage; transition determiner that determines a transition from a value greater than or equal to a remaining water amount threshold to a value less than the remaining water amount threshold; and water supply/drain controller that discharges all water in water storage by water drainage and supplies water to water storage by water supplier in a state where water storage does not have water when transition determiner determines the transition during micronization.

### BACKGROUND

### 1. Technical Field

The present disclosure relates to a liquid micronization apparatus.

### 2. Description of the Related Art

Conventionally, there is a liquid micronization apparatus that micronizes water stored in a water storage (for example, PTL 1). In a conventional liquid micronization apparatus, water stored in a water storage is pumped up by a water pumping pipe, the pumped water is radiated in a centrifugal direction, and the radiated water passes through a porous portion, thereby micronizing the water. In the liquid micronization apparatus of PTL 1, the water stored in the water storage is always maintained at a constant water level without excess or deficiency by the automatic water supply valve.

### CITATION LIST

### Patent Literature

PTL 1: Unexamined Japanese Patent Publication No. 2009-279514

### SUMMARY

In the conventional liquid micronization apparatus, only water in the water storage is vaporized when the humidification operation is continuously performed. When the operation of the liquid micronization apparatus is continued in this state, scale components such as calcium contained in water are concentrated in proportion to the use time and the amount of water used. As a result, there is a possibility that scale components are precipitated in the water storage, and the water pumping pipe and the drain hole are clogged.

Therefore, the present disclosure provides a liquid micronization apparatus capable of suppressing occurrence of clogging due to precipitation of scale components.

A liquid micronization apparatus according to the present disclosure includes: a water storage that stores water to be micronized; a water supplier that supplies water to the water storage; a drainage that drains water stored in the water storage; a remaining water amount acquirer that acquires a remaining water amount of the water storage; a transition determiner that determines a transition from a value greater than or equal to a remaining water amount threshold to a value less than the remaining water amount threshold based on the remaining water amount acquired by the remaining water amount acquirer; and a water supply/drain controller that discharges all water stored in the water storage by the water drainage and supplies water to the water storage by the water supplier in a state where the water storage does not have water when the transition determiner determines the transition.

According to the present disclosure, it is possible to provide a liquid micronization apparatus in which occurrence of clogging due to precipitation of scale components can be suppressed.

### BRIEF DESCRIPTION OF THE DRAWINGS

FIG. 1 is a schematic perspective view of a liquid micronization apparatus according to the present disclosure;

FIG. 2 is a schematic cross-sectional view illustrating an internal configuration of the liquid micronization apparatus according to the present disclosure;

FIG. 3 is a diagram illustrating a water stop mechanism of a water storage by a drainage and a water pumping pipe in the liquid micronization apparatus according to the present disclosure;

FIG. 4 is a schematic perspective view of a heat exchange ventilator including the liquid micronization apparatus according to the present disclosure;

FIG. 5 is a block diagram showing a configuration of a humidification controller in the liquid micronization apparatus according to the present disclosure; and

FIG. 6 is a flowchart showing a water supply/drain process procedure by the liquid micronization apparatus according to the present disclosure.

### DETAILED DESCRIPTIONS

Hereinafter, exemplary embodiments of the present disclosure will be described with reference to the accompanying drawings. The following exemplary embodiments illustrate preferred specific examples of the present disclosure. Thus, numerical values, shapes, materials, components, placement positions of the components and connection forms of the components, etc., which are described in the following exemplary embodiments, are illustrative and are not to limit the scope of the present disclosure. Accordingly, among the components in the following exemplary embodiments, the components that are not recited in the independent claims representing the most superordinate concept of the present disclosure are described herein as optional components. In each drawing, substantially the same components are denoted by the same reference numerals, and redundant description will be omitted or simplified.

### Exemplary Embodiment

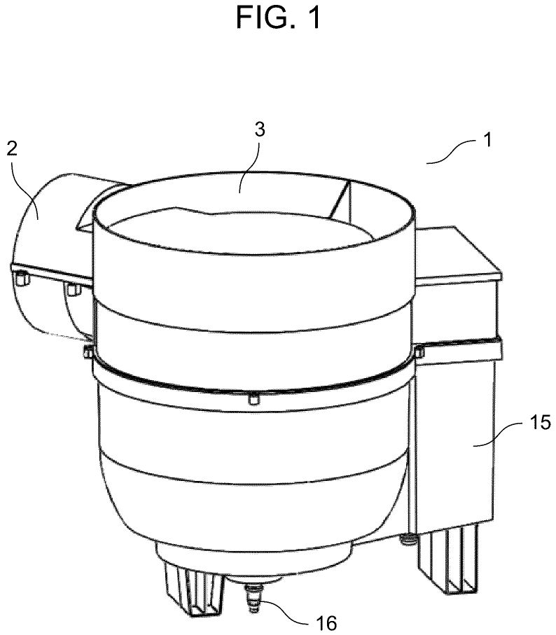

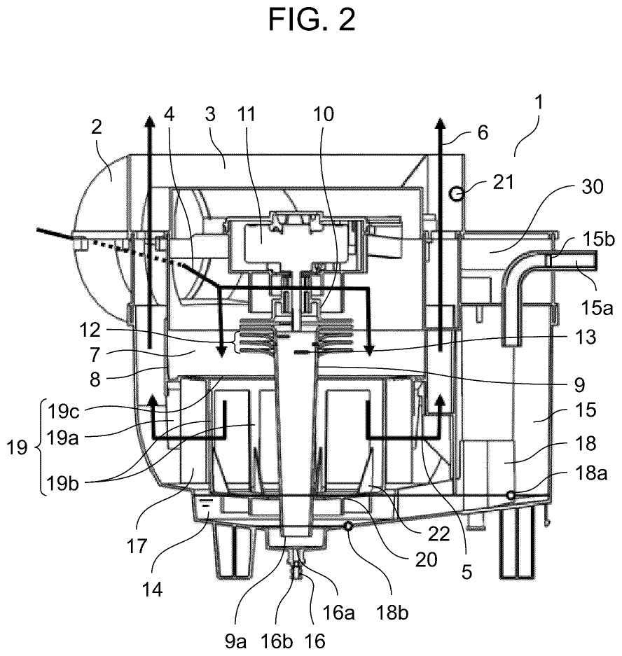

First, a schematic configuration of liquid micronization apparatus 1 according to an embodiment of the present disclosure will be described with reference to FIGS. 1 and 2. FIG. 1 is a schematic perspective view of a liquid micronization apparatus according to a first exemplary embodiment of the present disclosure. FIG. 2 is a schematic cross-sectional view illustrating an internal configuration of the liquid micronization apparatus according to the first exemplary embodiment of the present disclosure.

As illustrated in FIG. 1, liquid micronization apparatus 1 includes inlet 2 through which air is suctioned, and outlet 3 through which air suctioned through inlet 2 is blown out. Inlet 2 is provided on a side surface of liquid micronization apparatus 1. Outlet 3 is provided above liquid micronization apparatus 1.

As illustrated in FIG. 2, liquid micronization apparatus 1 formes air passage 4, air passage 5, and air passage 6 extending from inlet 2 to outlet 3. Liquid micronization apparatus 1 includes liquid micronization chamber 7 provided in air passage 4, air passage 5, and air passage 6, in which inlet 2, liquid micronization chamber 7, and outlet 3 communicate with each other.

Liquid micronization chamber 7 is a main part of liquid micronization apparatus 1, and performs micronization of water. In liquid micronization apparatus 1, air suctioned from inlet 2 is sent to liquid micronization chamber 7 via air passage 4. Liquid micronization apparatus 1 is configured to include water micronized in liquid micronization chamber 7 in the air passing through air passage 4, and blow out the air including the water from outlet 3 via air passage 5 and air passage 6 in this order. Here, air passage 5 is configured to change the direction in which the air containing water flows vertically downward in liquid micronization chamber 7 to the direction in which the air flows vertically upward in the outer periphery thereof. Air passage 6 is configured such that the air passing through air passage 5 flows upward in the vertical direction as it is, and is blown out from outlet 3.

Liquid micronization chamber 7 is provided with cylindrical collision wall 8 opened upward and downward. Collision wall 8 is fixed in liquid micronization chamber 7. Further, liquid micronization chamber 7 is provided with cylindrical water pumping pipe 9 that pumps water while rotating inside the chamber surrounded by collision wall 8. Water pumping pipe 9 has an inverted conical hollow structure, and includes round water pumping port 9a below, and rotary shaft 10 disposed in the vertical direction is fixed to the center of the top surface of the inverted conical shape above water pumping pipe 9. When rotary shaft 10 is connected to rotary motor 11 provided on the outer surface of liquid micronization chamber 7, the rotary motion of rotary motor 11 is conducted to water pumping pipe 9 through rotary shaft 10, and water pumping pipe 9 rotates. Rotary motor 11 is configured to perform a rotary motion based on a control signal from humidification controller 30 described later.

Water pumping pipe 9 includes a plurality of rotary plates 12 which formed on the top surface side of the inverted conical shape so as to protrude outward from the outer surface of Water pumping pipe 9. The plurality of rotary plates 12 is disposed so as to protrude outward from the outer surface of water pumping pipe 9 with predetermined intervals being provided respectively in the axial direction of rotary shaft 10 between rotary plates 12 vertically adjacent to each other. Since rotary plates 12 rotate together with water pumping pipe 9, they preferably have a horizontal disc shape coaxial with rotary shaft 10. Note that the number of rotary plates 12 is appropriately set in accordance with target performance or a dimension of water pumping pipe 9.

A wall surface of water pumping pipe 9 is provided with a plurality of openings 13 penetrating the wall surface of water pumping pipe 9. Each of the plurality of openings 13 is provided at a position where the inside of water pumping pipe 9 communicates with the upper surfaces of rotary plates 12 formed so as to protrude outward from the outer surface of water pumping pipe 9.

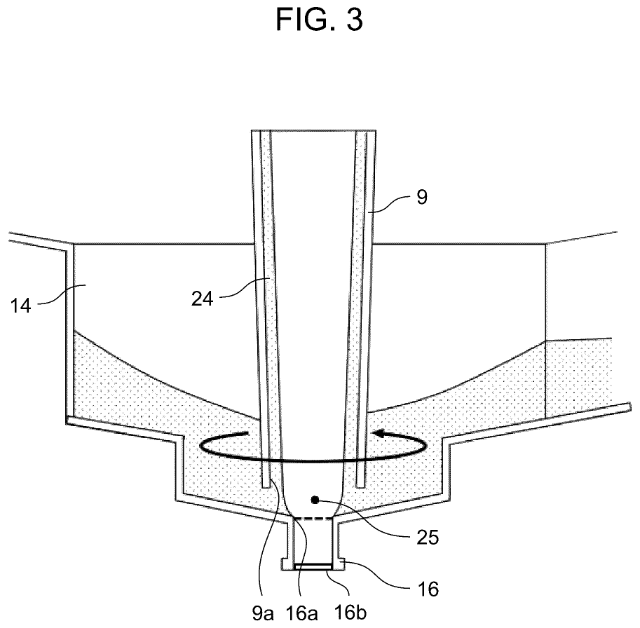

In a lower portion of liquid micronization chamber 7, water storage 14 is provided that stores water pumped by water pumping pipe 9 via water pumping port 9a vertically below water pumping pipe 9. Water storage 14 is designed to have a depth in which a part of the lower portion of water pumping pipe 9, for example, a length of about ⅓ to 1/100 of the conical height of water pumping pipe 9 is immersed. This depth can be provided in accordance with a required pumping discharge. The bottom surface of water storage 14 is formed into a mortar shape towards water pumping port 9a (see FIG. 3).

Water is supplied to water storage 14 by water supplier 15. Water supply pipe 15a is connected to water supplier 15, and water is directly supplied from tap water through water supply valve 15b by water supply pipe 15a, for example. Water supply valve 15b is, for example, an electric valve, and switches between an open state in which water is supplied to water storage 14 and a closed state in which water supply to water storage 14 is stopped. Water supplier 15 is provided vertically above a bottom surface of water storage 14. Water supplier 15 is preferably provided not only on a bottom surface of water storage 14 but also on a vertically upper side than an upper surface of water storage 14 (a surface of a maximum water level that can be stored in water storage 14). Water supplier 15 may be configured to draw only an amount of water required by the principle of siphon from a water tank provided outside liquid micronization chamber 7 in advance and supply the water to water storage 14.

Drainage 16 forming into a tubular shape is connected to a bottom surface of water storage 14. Round drain hole 16a provided at the position to which drainage 16 is connected is provided at the lowest position of the bottom surface of water storage 14 formed in a mortar shape. Drain valve 16b is provided vertically below drain hole 16a, and water is stopped and drained by drainage 16. Drain valve 16b is, for example, an electric valve, and switches between a closed state in which water is stopped at water storage 14 and an open state in which water is drained from water storage 14. By rotating water pumping pipe 9, water in water storage 14 can be stopped even when drain valve 16b is opened. Details of water stop by water pumping pipe 9 will be described later.

liquid micronization apparatus 1 is provided with water level sensor 18 that detects a water level of water storage 14 in order to acquire a remaining water amount in water storage 14. A plurality of water level sensors 18 may be provided according to the function of liquid micronization apparatus 1. For example, in the present exemplary embodiment, water level sensor 18 includes first water level sensor 18a that detects whether or not water storage 14 is in a full water state, and second water level sensor 18b that detects whether or not water storage 14 is in a water-shortage state. As water level sensor 18, any sensor such as a float switch or a thermistor may be used as long as the water level of water storage 14 can be detected.

First water level sensor 18a is turned off when the water in water storage 14 is less than the first water level threshold (full water state), and is turned on when the water in water storage 14 is equal to or more than the first water level threshold (full water state). First water level sensor 18a is installed to be turned on at a water level higher than or equal to the lower end of collision wall 8 with reference to the bottom surface of water storage 14, for example.

Second water level sensor 18b is turned on when the water in water storage 14 is equal to or higher than the second water level threshold (water-shortage state), and is turned off when the water in water storage 14 is lower than the second water level threshold (water-shortage state). For example, second water level sensor 18b is installed so as to be turned on at a water level higher than or equal to water pumping port 9a and lower than the lower end of collision wall 8 with respect to the bottom surface of water storage 14. In other words, water pumping port 9a is installed so as to be determined to be in a water-shortage state in a state where pumping is possible. Although details will be described later, in the water-shortage state, drain valve 16b is opened to start drainage. In order to reduce the drainage amount, second water level sensor 18b is preferably provided to be turned on at a water level at the same height as water pumping port 9a.

As described above, water level sensor 18 detects whether water storage 14 is in the full water state by switching first water level sensor 18a between on and off, and detects whether water storage 14 is in the water-shortage state by switching second water level sensor 18b between on and off. In other words, water level sensor 18 indirectly acquires the remaining water amount of water storage 14 by detecting the transition of the water level of water storage 14. Then, water level sensor 18 outputs information regarding on and off of first water level sensor 18a and second water level sensor 18b to humidification controller 30.

As another means for indirectly acquiring the remaining water amount of water storage 14, for example, humidity sensor 21 may be provided in outlet 3. Humidity sensor 21 detects the humidity of the air blown out from the outlet 3. When the remaining water amount in water storage 14 decreases, the amount of water micronized in liquid micronization chamber 7 decreases, and the humidity of the air blown out from outlet 3 decreases. Therefore, even when the humidity detected by humidity sensor 21 transitions from the humidity threshold or higher to the humidity threshold or less than, it is possible to detect that water storage 14 is in the water-shortage state.

A cylindrical eliminator 17 is provided below collision wall 8 (a space between collision wall 8 and water storage 14). Eliminator 17 is disposed to separate the inside and the outside of liquid micronization chamber 7, and collects a part of the micronized water droplets. Eliminator 17 is formed of a porous body through which air can flow. Eliminator 17 is fixed so as to be contained in eliminator holder 19 connected to a lower portion of collision wall 8. Specifically, eliminator holder 19 includes top plate 19c, first holder 19a extending vertically downward from top plate 19c, and second holder 19b extending vertically downward from top plate 19c inside first holder 19a (on water pumping pipe 9 side). Eliminator 17 is sandwiched and fixed between first holder 19a and second holder 19b of eliminator holder 19. Supporter 22 of water flow control plate 20 is connected to second holder 19b of eliminator holder 19.

Eliminator 17 is disposed in air passage 5, and collects water droplets in the water contained in the air passing through liquid micronization chamber 7 by circulating air in eliminator 17. As a result, the air flowing through eliminator 17 contains only vaporized water.

Water flow control plate 20 is provided above water storage 14 so as to cover water storage 14. Specifically, water flow control plate 20 is formed to have an outer diameter smaller than the inner wall diameter of water storage 14, and is provided to cover the upper side of water storage 14 below the space surrounded by eliminator 17. Water flow control plate 20 has a substantially disk-like shape, and has an opening (not illustrated) opened to a diameter that allows water pumping pipe 9 to pass through water flow control plate 20 in a central portion. Water flow control plate 20 has a plurality of supporters 22 on the upper surface side of the outer peripheral portion (outer edge), and is fixed to second holder 19b of eliminator holder 19 via supporter 22. Water flow control plate 20 prevents an increase in noise due to generation of bubbles of a water flow accompanying rotation of water pumping pipe 9.

Further, liquid micronization apparatus 1 is provided with a humidification controller 30. Humidification controller 30 controls the operation of liquid micronization apparatus 1 to control the humidification operation (micronization operation) in the humidification process. In addition, humidification controller 30 controls the water supply and the drainage of liquid micronization apparatus 1 based on, for example, information on the remaining water amount of water storage 14 acquired from first water level sensor 18a and second water level sensor 18b. As shown in FIG. 2, in the present embodiment, humidification controller 30 is provided inside liquid micronization apparatus 1, but humidification controller 30 may be disposed outside liquid micronization apparatus 1. Details of the control by humidification controller 30 will be described later.

Next, an operation principle of humidification (micronization of water) in liquid micronization apparatus 1 will be described with reference to FIG. 2.

First, air blowing from the outside (air suction from inlet 2) is started. Then, drain valve 16b is closed in a state where water does not exist in water storage 14. Further, rotary shaft 10 is rotated at first rotation speed R1 (For example, 2000 rpm) by rotary motor 11, and water pumping pipe 9 is rotated accordingly. Water is supplied from water supplier 15 to water storage 14 by opening water supply valve 15b. At this time, in water storage 14, the water supplied to water storage 14 is pumped up by pumping pipe 9 by a centrifugal force generated by the rotation of water pumping pipe 9. The water supplied to water storage 14 is stopped without being drained from drain hole 16a regardless of the open/close state of drain valve 16b, and the water supplied from water supplier 15 is stored in water storage 14. When first water level sensor 18a detects that water storage 14 is in the full water state, water supply valve 15b is closed to stop supply of water from water supplier 15 to water storage 14.

Subsequently, when rotary shaft 10 is rotated by rotary motor 11 at second rotation speed R2 which is a rotation speed equal to or higher than first rotation speed R1 and water pumping pipe 9 is rotated accordingly, the water stored in water storage 14 is pumped up by water pumping pipe 9 by the centrifugal force generated by the rotation. Here, second rotation speed R2 of rotary motor 11 (water pumping pipe 9) is set, for example, between 2000 rpm and 5000 rpm in accordance with a humidification amount for air. Since water pumping pipe 9 has the inverted conical hollow structure, water pumped up by rotation is pumped up along the inner wall of water pumping pipe 9. Then, the pumped water is discharged in the centrifugal direction from opening 13 of water pumping pipe 9 along rotary plates 12 and scattered as water droplets.

The water droplets scattered from rotary plates 12 micronize for flying in a space (liquid micronization chamber 7) surrounded by collision wall 8, and colliding with collision wall 8. On the other hand, the air passing through liquid micronization chamber 7 moves from above collision wall 8 to the inside of collision wall 8, and moves from below to the outside of collision wall 8 while containing water droplets micronized by collision wall 8. The air containing water droplets then passes through eliminator 17. As a result, liquid micronization apparatus 1 can humidify the air suctioned from inlet 2 and blow out the humidified air from outlet 3.

Note that the liquid to be micronized may be other than water, and may be, for example, a liquid such as hypochlorous acid water having bactericidal properties or deodorization properties. The micronized hypochlorous acid water is contained in the air suctioned from inlet 2 of liquid micronization apparatus 1, and the air is blown out from outlet 3, whereby sterilization or deodorization of the space in which liquid micronization apparatus 1 is placed can be performed.

Next, details of the water stop mechanism and the drainage mechanism of water storage 14 by drainage 16 and water pumping pipe 9 will be described with reference to FIG. 3. FIG. 3 is a view illustrating a water stop mechanism of water storage 14 by drainage 16 and water pumping pipe 9 in the liquid micronization apparatus according to the first exemplary embodiment of the present disclosure.

As illustrated in FIG. 3, in liquid micronization apparatus 1, the humidification operation is started, and when rotary motor 11 is rotated at third rotation speed R3 (For example, 2000 rpm), water pumping pipe 9 is rotated accordingly. Due to the centrifugal force of the rotation, vortex 24 is generated in the water of water storage 14 inside water pumping pipe 9. Water pumping pipe 9 forms gap 25 communicating between water pumping port 9a and drain hole 16a at the vortex center generated by the rotation of water pumping pipe 9. Accordingly, when gap 25 is sufficiently larger than drain hole 16a, water in water storage 14 can be prevented from flowing into drain hole 16a even when drain valve 16b is opened. That is, in liquid micronization apparatus 1, it is possible to suppress water in water storage 14 from being drained from drain hole 16a during the humidification operation (during the rotation operation of rotary motor 11 at second rotation speed R2).

On the other hand, when the rotation of rotary motor 11 is stopped, water pumping pipe 9 is stopped accordingly, and gap 25 disappears together with vortex 24. When drain valve 16b is opened at this time, water in water storage 14 flows into drain hole 16a. That is, in liquid micronization apparatus 1, water in water storage 14 can be drained through drain hole 16a by stopping the humidification operation (rotation operation of rotary motor 11).

As described above, when gap 25 is sufficiently larger than drain hole 16a, even when drain valve 16b is in the open state, it is possible to suppress (water stopping) the water of water storage 14 from being drained from drain hole 16a due to the rotation of water pumping pipe 9 during the humidification operation.

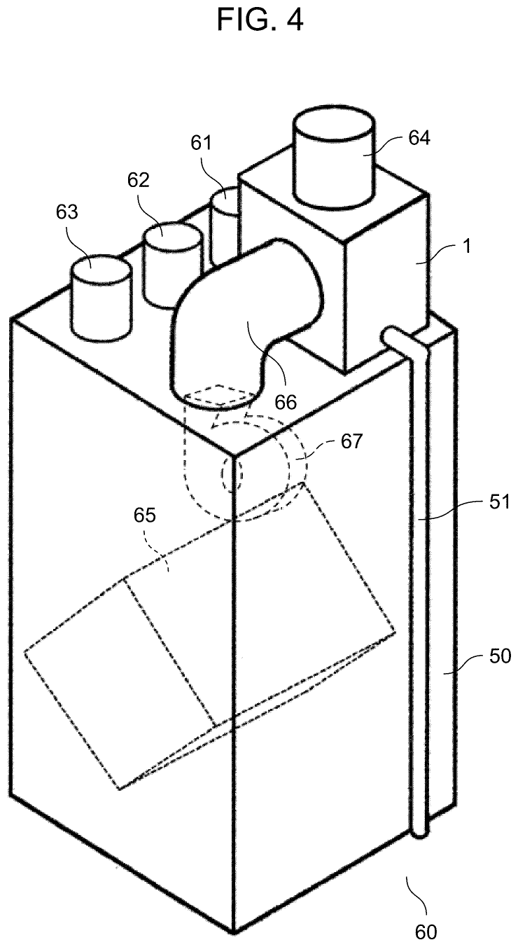

Next, heat exchange ventilator 60 including liquid micronization apparatus 1 according to the first exemplary embodiment will be described with reference to FIG. 4. FIG. 4 is a schematic perspective view of a heat exchange ventilator 60 including the liquid micronization apparatus 1 according to the first exemplary embodiment.

As illustrated in FIG. 4, heat exchange ventilator 60 includes liquid micronization apparatus 1, humidity collector 65, and blower 67. Heat exchange ventilator 60 blows the outside air suctioned from outside air inlet 63 (air whose humidity has been collected after passing through humidity collector 65) to inlet 2 (see FIG. 1) of liquid micronization apparatus 1 via connection duct 66. Liquid micronization apparatus 1 performs a humidification process on the air suctioned from inlet 2, blows out the humidified air from outlet 3 (see FIG. 1), and supplies the air into the room via air supply port 64.

Heat exchange ventilator 60 has a box-shaped main body case 50, and is used, for example, in a state of being placed on a floor. Inside air inlet 61, exhaust port 62, an outside air inlet 63, and air supply port 64 are provided on a top surface of main body case 50 (a surface on which liquid micronization apparatus 1 is mounted). Liquid micronization apparatus 1 is installed on a top surface of main body case 50. Humidity collector 65 and blower 67 are provided inside main body case 50.

The inside air inlet 61 is an inlet through which air (inside air) in the building is suctioned into heat exchange ventilator 60. Specifically, inside air inlet 61 communicates with and is connected to an indoor exhaust port for suctioning inside air via a duct (not illustrated) extending to a ceiling surface or a wall surface of each space in the building.

Exhaust port 62 is an outlet for blowing inside air from heat exchange ventilator 60 to the outside. Specifically, exhaust port 62 communicates with and is connected to an outdoor exhaust port through which inside air is blown out via a duct (not illustrated) extending to the building outer wall surface.

Outside air inlet 63 is an inlet through which air outside the building (outside air) is suctioned into heat exchange ventilator 60. Specifically, outside air inlet 63 communicates with and is connected to an outside air supply port that suctions outside air via a duct (not illustrated) extending to the building outer wall surface.

Air supply port 64 is an outlet for blowing outside air from heat exchange ventilator 60 into the room via liquid micronization apparatus 1. Specifically, air supply port 64 communicates with and is connected to an indoor air supply port through which outside air is blown out via a duct (not illustrated) extending to a ceiling surface or a wall surface of each space in the building. Heat exchange ventilator 60 and inlet 2 of liquid micronization apparatus 1 are connected via connection duct 66.

Humidity collector 65 is provided in main body case 50 so as to be positioned on the upstream side of blower 67. Humidity collector 65 has a humidity collect (humidity exchange) function of collecting (exchanging) the humidity of the air that passes through the inside of heat exchange ventilator 60 (In particular, the supply air passage) when the air is suctioned by the operation of blower 67. Humidity collector 65 is, for example, a desiccant heat exchanger or a heat pump heat exchanger.

Although not particularly shown, the supply air passage is an air passage through which fresh outdoor air (outside air) is suctioned through outside air inlet 63, passed through humidity collector 65, blower 67, connection duct 66, and liquid micronization apparatus 1 in this order, and supplied into the room through air supply port 64.

Blower 67 is a device for blowing outside air from outside air inlet 63 to air supply port 64. Blower 67 circulates outside air inside humidity collector 65 by blowing air. Examples of blower 67 include a cross flow fan and a blower fan. Blower 67 is configured to perform a blowing operation based on a control signal from a heat exchange ventilation controller (not illustrated) that controls heat exchange ventilator 60.

Heat exchange ventilator 60 is provided with water supply/drain pipe 51. Supply and drainage of water to and from liquid micronization apparatus 1 are performed by water supply/drain pipe 51. Specifically, one end of water supply/drain pipe 51 is connected to water supply pipe 15a (see FIG. 2) and drainage 16 (see FIG. 2) of liquid micronization apparatus 1. The other end of water supply/drain pipe 51 is connected to a water supply facility and a drainage facility of a house or a facility.

As described above, in heat exchange ventilator 60, the moisture discharged to the outdoors at the time of ventilation is collected into the air supplied into the room, and in a case where the moisture is not completely collected by humidity collector 65, it is possible to supplement or add more moisture at the time of allowing the moisture to pass through liquid micronization apparatus 1, so that the room can be humidified and maintained in a comfortable humidity range.

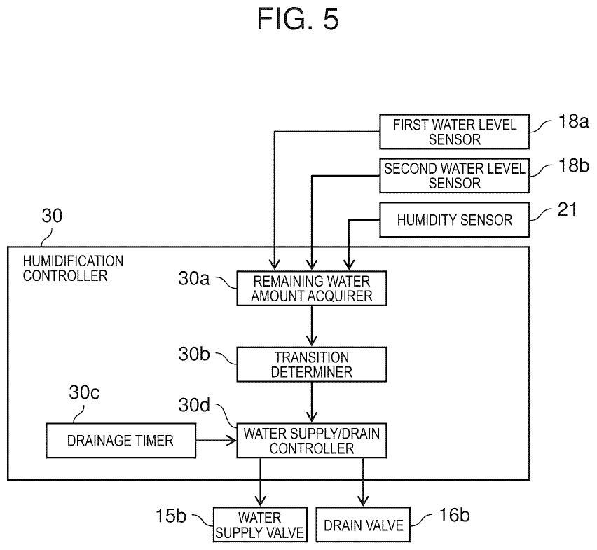

Next, humidification controller 30 of liquid micronization apparatus 1 will be described with reference to FIG. 5. FIG. 5 is a block diagram illustrating a configuration of humidification controller 30 in liquid micronization apparatus 1 according to the first exemplary embodiment of the present disclosure.

As illustrated in FIG. 5, humidification controller 30 includes a remaining water amount acquirer 30a, transition determiner 30b, drainage timer 30c, and water supply/drain controller 30d. Hereinafter, for the sake of description, the value of the remaining water amount at the water level threshold at which the water level of water storage 14 becomes full is referred to as a full water threshold, and the value of the remaining water amount at the water level threshold at which the water level of water storage 14 becomes water-shortage is referred to as a remaining water amount threshold. In other words, the full water threshold is the remaining water amount at the water level at which first water level sensor 18a switches from off to on. The remaining water amount threshold is a remaining water amount at a water level at which second water level sensor 18b is switched from on to off.

Remaining water amount acquirer 30a acquires information of first water level sensor 18a and information of second water level sensor 18b as information on a remaining water amount of water storage 14. Remaining water amount acquirer 30a may acquire information of humidity sensor 21 instead of water level sensor 18 as information on the remaining water amount of water storage 14, or may acquire both water level sensor 18 and humidity sensor 21. Remaining water amount acquirer 30a outputs the acquired information to transition determiner 30b.

Transition determiner 30b determines the transition of the remaining water amount of water storage 14 based on the information about the remaining water amount of water storage 14 acquired by remaining water amount acquirer 30a. For example, when the information acquired from first water level sensor 18a transitions from off to on, it is determined that the remaining water amount in water storage 14 has transitioned from less than the full water threshold to equal to or more than the full water threshold. In other words, it is determined that water storage 14 is in the full tank state. Further, when the information acquired from second water level sensor 18b transitions from on to off, it is determined that the water level of the remaining water amount of water storage 14 has transitioned from equal to or more than the remaining water amount threshold to less than the remaining water amount threshold. In other words, it is determined that water storage 14 is in the water-shortage state. Transition determiner 30b specifies control contents for water supply valve 15b or drain valve 16b based on the determination result, and outputs the control contents to drainage timer 30c and water supply/drain controller 30d.

Drainage timer 30c measures a time elapsed from the start of draining. In other words, drainage timer 30c measures the time elapsed after drain valve 16b is opened. For example, drainage timer 30c sets 20 as an initial value, decreases the count by 1 every second until the count becomes 0, and transmits a signal to water supply/drain controller 30d when the count becomes 0.

Water supply/drain controller 30d outputs a signal (control signal) for controlling the opening/closing operation of water supply valve 15b and the opening/closing operation of drain valve 16b based on the control contents determined by transition determiner 30b. Water supply/drain controller 30d is electrically connected to water supply valve 15b and drain valve 16b.

As described above, humidification controller 30 controls water supply valve 15b and drain valve 16b. In other words, the water supply operation to water storage 14 or the drainage operation from water storage 14 is controlled based on the change in the water level of water storage 14 or the change in the humidification amount of liquid micronization apparatus 1.

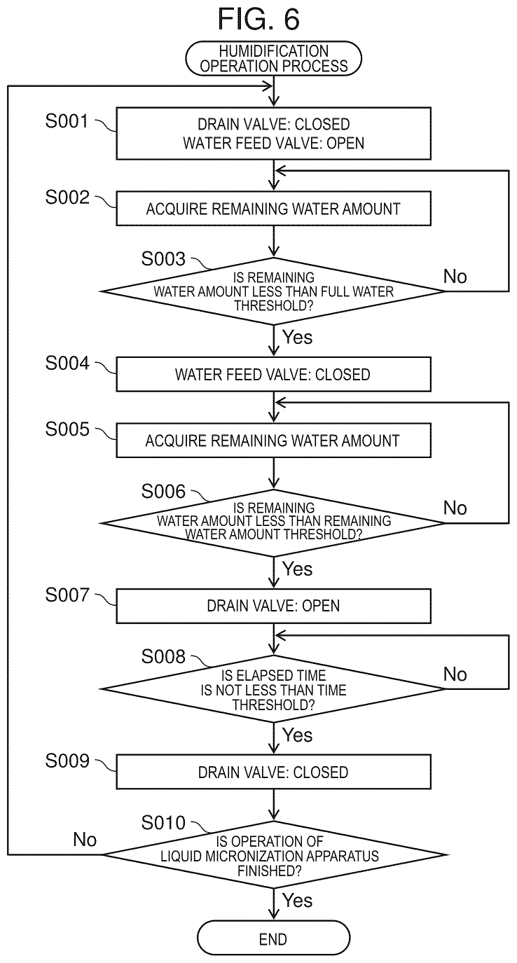

Next, a procedure of water supply/drain process in the humidification operation of liquid micronization apparatus 1 will be described with reference to FIG. 6. FIG. 6 is a flowchart showing processing of water supply/drain control by the liquid micronization apparatus 1 according to the first exemplary embodiment of the present disclosure. Here, each step in the flowchart is assigned a number with S as a prefix. For example, S001 or the like indicates a processing step. Note that the magnitude of the numerical value indicating the processing step is not related to the processing order.

With reference to FIG. 6, a processing procedure of water supply/drain control of liquid micronization apparatus 1 will be described.

When liquid micronization apparatus 1 starts the humidification process operation, water supply/drain controller 30d closes drain valve 16b and opens water supply valve 15b, and water supplier 15 starts supply of water to water storage 14 (S001).

Remaining water amount acquirer 30a acquires the remaining water amount of water storage 14 (S002). Here, information is acquired from the first water level sensor.

Transition determiner 30b determines whether the remaining water amount in water storage 14 has transitioned from less than the full water threshold to greater than or equal to the full water threshold (S003).

When the remaining water amount in water storage 14 does not transition from less than the full water threshold to the full water threshold or more, in other words, when the water in water storage 14 is not in the full water state (S003: No), water supply/drain controller 30d continues the open state of water supply valve 15b (returns to S002).

On the other hand, when the remaining water amount in water storage 14 transitions from a value less than the full water threshold value to a value equal to or more than the full water threshold value, in other words, when the water in water storage 14 is in the full water state (S003: Yes), water supply/drain controller 30d closes water supply valve 15b (S004).

With such control, the water in water storage 14 is fully filled. When the water supply valve 15b is closed after the water supply process for supplying water to the water storage 14 is completed, the water in water storage 14 is gradually reduced by the humidification operation of liquid micronization apparatus 1. In other words, the remaining water amount of water storage 14 decreases, and the water level of water storage 14 gradually decreases.

Remaining water amount acquirer 30a acquires the remaining water amount of water storage 14 (S005). Here, the remaining water amount of information is acquired from second water level sensor 18b or humidity sensor 21.

Transition determiner 30b determines whether the remaining water amount of water storage 14 has transitioned from the remaining water amount threshold or more to less than the remaining water amount threshold (S006).

When the remaining water amount of water storage 14 does not transition from the remaining water amount threshold or more to the remaining water amount threshold or less, in other words, when the water of water storage 14 is not in the water-shortage state (S006: No), water supply/drain controller 30d continues the closed state of drain valve 16b (returns to S005).

On the other hand, when the remaining water amount of water storage 14 transitions from the remaining water amount threshold or more to less than the remaining water amount threshold, in other words, when the water of water storage 14 is in a water-shortage state (S006: Yes), water supply/drain controller 30d always opens drain valve 16b (S007).

Drainage timer 30c measures a time elapsed after drain valve 16b is opened (S008).

When the time measured by drainage timer 30c is less than the time threshold (S008: No), water supply/drain controller 30d continues the open state of drain valve 16b.

On the other hand, when the time measured by drainage timer 30c is equal to or longer than the time threshold (S008: Yes), water supply/drain controller 30d closes drain valve 16b (S009).

When the operation of liquid micronization apparatus 1 is finished (S010: Yes), the humidification operation process is finished.

On the other hand, when the operation of liquid micronization apparatus 1 is continued (S010: No), water supply to water storage 14 is started again (the process returns to S001).

By such control, the water supplied by water supplier 15 is always drained by drainage 16. In other words, water is supplied to water storage 14 after remaining water is always drained.

When water supply treatment is performed without draining water during the humidification operation as in the related art, in other words, when water is added in a state where water still remains, scale components such as calcium contained in water are concentrated in proportion to the use time and the amount of water used. As a result, there is a possibility that scale components are precipitated in water storage 14, and water pumping pipe 9 and drain hole 16a are clogged.

In the present exemplary embodiment, remaining water is always drained once when water supply to water storage 14 is provided once. In other words, since water is newly supplied in a state where no water remains in water storage 14, concentration of the scale components in water storage 14 can be suppressed. As a result, clogging in liquid micronization apparatus 1 can be suppressed.

### (Summary of the Invention)

A liquid micronization apparatus according to the present disclosure micronizes water stored in a water storage, and includes: a water supplier that supplies water to the water storage; a drainage that drains water stored in the water storage; a remaining water amount acquirer that acquires a remaining water amount of the water storage; a transition determiner that determines a transition from a value greater than or equal to a remaining water amount threshold to a value less than the remaining water amount threshold based on the remaining water amount acquired by the remaining water amount acquirer; and a water supply/drain controller that discharges all water in the water storage by the water drainage and supplies water to the water storage by the water supplier in a state where the water storage does not have water when the transition determiner determines the transition during micronization.

According to such a configuration, since water is newly supplied in a state where no water remains in water storage 14, clogging in liquid micronization apparatus 1 can be suppressed.

Further, a water level sensor that detects the water level of the water storage may be further included, and the transition determiner may be configured to determine that the water level has transitioned from the remaining water amount threshold or more to the remaining water amount threshold or less when the water level detected by the water level sensor has transitioned from the water level threshold or more to the water level threshold or less.

According to such a configuration, the water level can be indirectly acquired as the remaining water amount.

Further, a humidity sensor that detects the humidity of the air blown out from the outlet through which the air containing the miniaturized water is blown out may be further included, and the transition determiner may be configured to determine that the humidity has transitioned from the remaining water amount threshold or more to the remaining water amount threshold or less when the humidity detected by the humidity sensor has transitioned from the humidity threshold or more to the humidity threshold or less.

According to such a configuration, the humidification amount can be indirectly acquired as the remaining water amount.

Further, the water supply/drain controller may be configured to further include a drainage timer that measures a time elapsed from the start of the drainage, and when the time measured by the drainage timer is equal to or longer than a predetermined time threshold value, the water supply/drain controller may stop the drainage regardless of the determination result of the transition determiner and supply water to the water storage by the water supplier.

According to such a configuration, water supply can be started in a state where no water in water storage 14 remains reliably.

Further, the drainage may include a drain hole for draining water from the water storage, and a drain valve for opening and closing the drain hole, and the water supply/drain controller may be configured to always bring the drain valve into the open state when the transition determiner determines the transition at the time of micronization, and bring the drain valve into the closed state regardless of the determination result of the transition determiner when the time measured by the drainage timer is equal to or longer than the time threshold.

In addition, a configuration may be adopted in which a cylindrical water pumping pipe having a water pumping port on a vertically lower side and configured to discharge water suctioned up from the water storage at the water pumping port in a centrifugal direction along with rotation, and a collision wall configured to cause the water discharged from the pumping pipe to collide with each other to miniaturize the water.

The liquid micronization apparatus according to the present disclosure is useful as a device that vaporizes a liquid, such as a humidifier and a hypochlorous acid vaporizer for sterilization or deodorization.

### REFERENCE MARKS IN THE DRAWINGS

1: liquid micronization apparatus

2: inlet

3: outlet

4: air passage

5: air passage

6: air passage

7: liquid micronization chamber

8: collision wall

9: water pumping pipe

9a: water pumping port

10: rotary shaft

11: rotary motor

12: rotary plate

13: opening

14: water storage

15: water supplier

15a: water supply pipe

15b: water supply valve

16: drainage

16a: drain hole

16b: drain valve

17: eliminator

18: water level sensor

18a: first water level sensor

18b: second water level sensor

19: eliminator holder

19a: first holder

19b: second holder

19c: top plate

20: water flow control plate

21: humidity sensor

22: supporter

24: vortex

25: gap

30: humidification controller

30a: remaining water amount acquirer

30b: remaining water amount acquirer

30c: drainage timer

30d: water supply/drain controller

50: main body case

51: water supply/drain pipe

60: heat exchange ventilator

61: inside air inlet

62: exhaust port

63: outside air inlet

64: air supply port

65: humidity collector

66: connection duct

67: blower

What is claimed is:

1. A liquid micronization apparatus comprising:
a water storage that stores water to be micronized;
a water supplier that supplies water to the water storage;
a drainage that drains water stored in the water storage;
a remaining water amount acquirer that acquires a remaining water amount of the water storage;
a transition determiner that determines a transition from a value greater than or equal to a remaining water amount threshold to a value less than the remaining water amount threshold based on the remaining water amount acquired by the remaining water amount acquirer; and
a water supply/drain controller that drains all water stored in the water storage by the water drainage and supplies water to the water storage by the water supplier in a state where the water storage does not have water when the transition determiner determines the transition.

2. The liquid micronization apparatus according to claim 1, further comprising a water level sensor that detects a water level of the water storage,
wherein when the water level detected by the water level sensor has transitioned from a value greater than or equal to the remaining water amount threshold to a value less than the remaining water amount threshold, the transition determiner determines that the water level has transitioned from a value greater than or equal to the remaining water amount threshold to a value less than the remaining water amount threshold.

3. The liquid micronization apparatus according to claim 1, further comprising a humidity sensor that detects humidity of air blown out from an outlet through which air containing the micronized water is blown out,
wherein when the humidity detected by the humidity sensor has transitioned from a value greater than or equal to the humidity threshold to a value less than the humidity threshold, the transition determiner determines that a water level has transitioned from a value greater than or equal to the remaining water amount threshold to a value less than the remaining water amount threshold.

4. The liquid micronization apparatus according to claim 1, further comprising a drainage timer that measures a time elapsed from a start of the drainage,
wherein when the time measured by the drainage timer is longer than or equal to a time threshold, the water supply/drain controller stops the drainage and supplies water to the water storage by the water supplier regardless of a determination result of the transition determiner.

5. The liquid micronization apparatus according to claim 4, wherein the drainage includes
a drain hole for draining water from the water storage and
a drain valve that opens and closes the drain hole,
wherein the water supply/drain controller,
when the transition determiner determines the transition during the micronization, always brings the drain valve into an open state, and
when the time measured by the drainage timer is longer than or equal to the time threshold, brings the drain valve into a closed state regardless of the determination result of the transition determiner.

6. The liquid micronization apparatus according to claim 5 comprising:
a cylindrical water pumping pipe that has a vertically downward water pumping port and discharges water suctioned from the water storage at the water pumping port in a centrifugal direction in accordance with rotation; and
a collision wall to which the water discharged from the water pumping pipe collides to be micronized.
